(19) United States
(12) Patent Application Publication
(10) Pub. No.: US 2011/0027412 A1
(43) Pub. Date: Feb. 3, 2011

(54) Compositions and Methods for Promoting Gastrointestinal and/or Cardiovascular Health

(76) Inventors: Kris Eugene Spence, Portage, MI (US); Graham John Myatt, Bracknell (GB)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/841,210

(22) Filed: Jul. 22, 2010

Related U.S. Application Data
(60) Provisional application No. 61/230,123, filed on Jul. 31, 2009.

(51) Int. Cl. A23L 1/308; A23L 1/28; A23L 1/302; A23L 1/05; A23L 1/304

(52) U.S. Cl. 426/2; 426/93; 426/61; 426/72; 426/560

(57) ABSTRACT

A composition for promoting gastrointestinal and/or cardiovascular health comprising a gelling dietary fiber and a non-gelling dietary fiber in a weight ratio of from about 5:1 to about 1:2.5; a coating component and a wetting component in a weight ratio of from about 20:1 to about 1:1; wherein a weight ratio of coating component plus wetting component to said gelling dietary fiber or said non-gelling dietary fiber is from about 25:1 to about 1:5 is disclosed. Also disclosed herein is a composition for promoting gastrointestinal and/or cardiovascular health comprising a gelling dietary fiber; a non-gelling dietary fiber; and an amount of a coating component sufficient to coat the particles of the gelling dietary fiber, such that the water-absorbing ability is reduced and the organoleptic properties of the composition are improved. Methods of promoting gastrointestinal and/or cardiovascular health are also included.

### CROSS REFERENCE TO RELATED APPLICATIONS

This application claims the benefit of U.S. Provisional Application No. 61/230,123 filed on Jul. 31, 2009.

### FIELD OF THE INVENTION

The invention relates generally to compositions for promoting gastrointestinal and/or cardiovascular health. More particularly the invention relates to compositions for promoting gastrointestinal and/or cardiovascular health containing dietary fiber, which may include soluble and insoluble dietary fiber and gelling and non-gelling dietary fiber, some or all of which are also prebiotic. Most particularly, the invention relates to a composition for promoting gastrointestinal and/or cardiovascular health including a gelling dietary fiber and a non-gelling dietary fiber, and coating and wetting components. The invention also relates to a composition for promoting gastrointestinal and/or cardiovascular health including a gelling dietary fiber; a non-gelling dietary fiber; and an amount of a coating component sufficient to coat the particles of said gelling dietary fiber, such that the water-absorbing ability is reduced and the organoleptic properties of the composition are improved. The invention also relates to methods of promoting gastrointestinal and/or cardiovascular health comprising administering the compositions to a mammal.

### BACKGROUND OF THE INVENTION

In recent years there has been a growing appreciation of the benefits of a high fiber diet. Benefits include the regulation of bowel function, reduction of periodic and chronic gastrointestinal disorders, and cardiovascular health benefits such as reduction of serum cholesterol. High fiber intake has also been associated with a decreased incidence of certain types of cancer. In addition, there has been an increasing understanding of the different types of dietary fiber, and their specific benefits and functions, as well as growing interest in and understanding of “prebiotics”, some of which can be a sub-group of fiber. “Prebiotics” are generally understood to be those dietary fibers and other substances which provide the beneficial effect of favorably influencing the growth of probiotic microorganisms. As prebiotics have been further studied it has become known that certain substances, for example dietary fibers, function as prebiotics for certain probiotic microorganisms and not others, or function as better prebiotics for some probiotic microorganisms versus others. Therefore, there is growing interest is providing dietary fibers that provide not only traditionally known benefits of dietary fiber but which also function as prebiotics to balance and maintain healthy populations of probiotic microorganisms in the gastrointestinal tract.

It is generally recommended that the target percentage daily value for dietary fiber intake for humans is about 25 g for a 2,000 calorie per day diet, and about 30 g for a 2,500 calorie per day diet. However, the daily diets of a large portion of the population, particularly in the U.S., fall well below these targeted amounts. Therefore, the need exists for ways for individuals to increase their daily intake of fiber.

However, many dietary fibers which are excellent sources of dietary fiber are known as gelling dietary fibers, which normally form a gelatinous mass on contact with water. Psyllium is one such example. Psyllium is generally introduced into the diet by dispersing it in water or an aqueous beverage which is ingested by the user. Psyllium can also be incorporated into baked goods such as cookies and wafers. However, due to psyllium's mucilaginous gelling properties, it can be difficult to incorporate effective amounts of psyllium into baked goods without producing undesirable results. Baked goods containing gelling dietary fibers also tend to have less than desirable organoleptic properties such as lodging and packing into the teeth in gelled clumps.

Therefore, there remains a need for improved compositions that contain gelling dietary fibers but overcome the drawbacks associated with such gelling dietary fibers. In addition, there exists a need to provide compositions that provide effective total amounts of dietary fiber while providing different types of dietary fiber in order to provide different beneficial effects, including, gastrointestinal, cardiovascular and prebiotic effects, in a composition that is palatable, easy to use, safe, and has pleasing organoleptic properties.

### SUMMARY OF THE INVENTION

The present invention comprises a composition for promoting gastrointestinal and/or cardiovascular health comprising a gelling dietary fiber and a non-gelling dietary fiber in a weight ratio of from about 5:1 to about 1:2.5; a coating component and wetting component in a weight ratio of from about 20:1 to about 1:1; and wherein a weight ratio of coating component plus wetting components to gelling dietary fiber or non-gelling dietary fiber is from about 25:1 to about 1:5. Also disclosed herein is a composition for promoting gastrointestinal and/or cardiovascular health comprising: a gelling dietary fiber; a non-gelling dietary fiber; and an amount of a coating component sufficient to coat the particles of said gelling dietary fiber, such that the water-absorbing ability is reduced and the organoleptic properties of the composition are improved. Methods of promoting gastrointestinal and/or cardiovascular health comprising administering the compositions to a mammal are also included.

### DETAILED DESCRIPTION OF THE INVENTION

The present invention comprises a composition for promoting gastrointestinal and/or cardiovascular health comprising a gelling dietary fiber and a non-gelling dietary fiber in a weight ratio of from about 5:1 to about 1:2.5; a coating component and wetting component in a weight ratio of from about 20:1 to about 1:1; and wherein a weight ratio of coating component plus wetting component to gelling dietary fiber or non-gelling dietary fiber is from about 25:1 to about 1:5. Also disclosed herein is a composition for promoting gastrointestinal and/or cardiovascular health comprising a gelling dietary fiber; a non-gelling dietary fiber; and an amount of a coating component sufficient to coat the particles of said gelling dietary fiber, such that the water-absorbing ability is reduced and the organoleptic properties of the composition are improved. Methods of promoting gastrointestinal and/or cardiovascular health comprising administering the compositions to a mammal are also included.

Trade names for products or components including various ingredients may be referenced herein. The inventors herein do not intend to be limited by materials under a certain trade name.

As used herein the term “dietary fiber” means fiber that is suitable for consumption by a mammal. Dietary fiber can include any soluble or insoluble fiber, and can include gelling and non-gelling dietary fiber. Some dietary fibers can be gelling or non-gelling depending upon the composition in which they are used and the treatment of the composition and/or the fiber. By way of non-limiting example, whether a material may gel may depend on the amount of water available, the temperature, whether the composition is cooked or baked or not, the presence of chemical ions, changes in pH, and whether the fiber is chemically modified (i.e. new atoms, molecules, functional groups, etc. added to alter the structure or properties) and/or how the fiber is modified. Dietary fiber also includes fibers which are fermentable by, and favorably influence the growth of, probiotic microorganisms. Such dietary fibers are also termed “prebiotic” as further described below.

As used herein “soluble fiber” means fiber that is soluble in water, and provides known beneficial effects on gastrointestinal health, including but not limited to absorbing water; softening stool; providing bulk; decreasing pH of the gastrointestinal tract; producing volatile fatty acids when metabolized; decreasing intestinal transit time; beneficially influencing various blood parameters; having a beneficial effect on cholesterol and lipid metabolism such as reducing cholesterol, triglycerides and phospholipids and improving (by increasing) HDL to LDL ratio; decreasing the incidence of bacterial translocation; and preventing the deleterious effects of oxygen free radicals, decreasing or modifying blood glucose absorption; and increasing satiety. Soluble fibers balance the intestinal pH via their fermentation and production of short chain fatty acids by bacteria in the lower gastrointestinal tract.

As used herein “insoluble fiber” means fiber that is insoluble in water, passes through the body largely unchanged and provides known beneficial effects on gastrointestinal health. Insoluble fibers are mainly plant materials containing plant cell wall components and lignin that are non-digestible. Insoluble fiber adds bulk to the stool, speeds the passage of foods through the digestive system and facilitates regularity. It may also be partially fermented by the bacteria in the gastrointestinal tract. Insoluble fiber may also increase satiety when added as bulk to foods or the diet.

As used herein “prebiotic” means those dietary fibers and other substances which provide the beneficial effect of favorably influencing the growth of probiotic microorganisms. Particularly useful prebiotics preferentially influence the growth of probiotic microorganisms, but do not favorably influence the growth of pathogenic microorganisms. Inulin and fructooligosaccharides, for example, are known to be fermented preferentially by Bifidobacterium, but not by certain pathogenic microorganisms. Prebiotics share many of the characteristics of dietary fibers, and many are considered to be dietary fibers. Particularly useful in the present invention are gelling and non-gelling dietary fibers which are also prebiotic.

In the description of the invention various embodiments or individual features are disclosed. As will be apparent to the ordinarily skilled practitioner, all combinations of such embodiments and features are possible and can result in preferred executions of the present invention.

The compositions herein may comprise, consist essentially of, or consist of any of the elements as described herein. As used in the specification and claims, the singular forms “a”, “an” and “the” include both the singular and plural unless the context clearly dictates otherwise or unless specified otherwise.

All percentages and ratios are calculated by weight unless otherwise indicated. All percentages and ratios are calculated based on the total composition unless otherwise indicated.

### Compositions

The compositions of the present invention include a gelling dietary fiber and a non-gelling dietary fiber; a coating component and a wetting component.

In an embodiment of the invention, the gelling dietary fiber and non-gelling dietary fiber may be included in a weight ratio of from about 5:1 to about 1:2.5, alternatively from about 3:1 to about 1:2, and alternatively about 1:1.

In another embodiment of the invention, a coating component and a wetting component may be included in a weight ratio of from about 20:1 to about 1:1, alternatively from about 10:1 to about 1:1, alternatively about 5:1 to about 1:1, alternatively about 3:1 to about 1:1, and alternatively about 1:1.

In another embodiment of the invention, a coating component and wetting component are included a weight ratio of coating component plus wetting component to either gelling dietary fiber or non-gelling dietary fiber of from about 25:1 to about 1:5, alternatively from about 10:1 to about 1:5, alternatively from about 2:1 to about 1:5, and alternatively about 2:1.

The use of both gelling and non-gelling dietary fiber provides the compositions with the benefits of both types of fiber. The inclusion of both gelling and non-gelling dietary fiber allows the compositions to contain effective total amounts of fiber while allowing gelling dietary fiber to be used, but mitigates some of the unpleasant characteristics of gelling fibers used in chewable compositions, such as gelling in the mouth, packing into the teeth, and requiring ingestion of large amounts of liquids while eating the composition containing the gelling dietary fiber.

The inclusion of a coating component in addition to use of a non-gelling fiber further reduces the unpleasant effects of gelling dietary fibers. The coating component is pre-mixed with the gelling dietary fiber to coat the particles of the gelling dietary fiber to provide better mouth feel, and limit or reduce the water absorption and gelling of the gelling dietary fiber, thus reducing gelling in the mouth and packing into the teeth, while improving stability of the composition. The use of a wetting component provides wetting to components of the composition that are in dried or powdered form to ensure thorough mixing.

The compositions herein may be made in various forms made into a dough during processing, produced by conventional baking methods and which are safe for oral administration to mammals, particularly humans. Non-limiting examples of such forms include cookies, wafers, chewable tablets, breads, pancakes, biscuits, muffins, donuts, pizza and pie crusts, breakfast breads such as croissants, bagels, “english muffins”, pretzels, pasta, nutrition bars, and combinations thereof. Conventional baking methods include conventional and industrial ovens, microwave ovens, skillets, bread machines and the like.

The compositions may also include a topping. The topping may contain one or more components or ingredients of the composition. For example, a wafer may be made and contain the non-gelling dietary fiber and be topped with a topping (such as a chocolate coating) containing the gelling dietary fiber. As used herein the composition includes any form described above and any topping that may be applied thereon.

### Gelling Dietary Fiber

The compositions may include one or more gelling dietary fibers. As used herein “gelling” dietary fiber refers to dietary fiber that forms a gel or gelatinous mass by absorbing water when exposed to water. Particularly useful are those which are also useful as prebiotics, although it is not required that the gelling dietary fiber be prebiotic.

Non-limiting examples of gelling dietary fibers useful in the present invention include: psyllium; non-modified pectins; mannans such as guar gum, locust bean gum, konjac, xanthan gum, glucomannans, galactomannans; beta-glucans; arabinans; galactans; aligns; agar; propylcelluloses and methylcelluloses such as hydroxypropylmethyl cellulose and carboxymethyl cellulose; gelling carrageenans; and combinations thereof. Particularly useful gelling dietary fibers are those which are also useful as prebiotics.

When present the gelling dietary fiber is present in an amount of from about 1% to about 15%, alternatively from about 5% to about 15%, alternatively from about 5% to about 10%, and alternatively from about 7% to about 9%, by weight of the composition.

The present compositions provide from about 0.5 g to about 5 g, alternatively from about 1 g to about 3 g, and alternatively from about 1.5 g to about 2.5 g of gelling dietary fiber per recommended dose or serving.

### Non-Gelling Dietary Fiber

The compositions may include one or more non-gelling dietary fibers. Particularly useful are those which are also useful as prebiotics, though it is not required that the non-gelling fiber be prebiotic. As used herein, the term “non-gelling” used in relation to a fiber means a fiber which gels too poorly for use as a traditional gelling agent to set foodstuffs. A “non-gelling” fiber of the present invention may increase viscosity to some extent, but does not produce a gel under conditions associated with traditional gelling agents as would be understood by one of skill in the art.

Non-limiting examples of non-gelling dietary fiber useful in the present invention include: inulin; gum Arabic (acacia gum); larch arabinogalactan; resistant dextrins; high methoxyl pectin; cellulose; raffinose; stachyose; oligosaccharides such as fructooligosaccharides, soy oligosaccharides, galactooligosaccharides, gentioligosaccharides, xylooligosaccharides, isomaltooligosaccharides and arabino-xylanoligosaccharides; lactulose; hydrolyzed guar gum; lignins; brans and grain fibers such as oat hull fiber; oat bran; wheat bran; rice bran; non-gelling carageenans; retrograded starch; resistant starch; slow digesting starch; resistant maltodextrins; sugar beet fiber; oilseed fibers such as from flax; and combinations thereof. Inulin is a non-limiting example of a soluble, non-gelling dietary fiber that is also prebiotic.

When present the non-gelling dietary fiber is present in an amount ranging from about 1% to about 30%, alternatively from about 5% to about 20%, alternatively from about 5% to about 10%, and alternatively from about 7% to about 9%, by weight of the composition.

The present compositions provide from about 0.5 g to about 7 g, alternatively from about 1 g to about 4 g, and alternatively from about 1.5 g to about 2.5 g of non-gelling dietary fiber per dose or serving.

### Coating Components

The compositions may include one or more coating components. Coating components useful in the compositions can be fat components and/or fat replacement components. Fat components can be saturated or un-saturated, solid or liquid at 25° C. and combinations thereof. Fat components that are particularly useful as coating components may be derived from plants, and include vegetable fats and fats from plant seeds, though animal fats could be used.

One of the important properties of a fat is its solid fat content. Fats may retain their solid character with solid fat contents as low as about 12% to about 15%. Below this level, fats become pourable and lose their plastic character.

When the coating component is a fat the coating has a solid fat content (SFC) of at least about 30% at 20° C. Non-limiting examples of coating components having such fat include chocolate; cocoa butter; chocolate liquor (US nomenclature, also called “cocoa mass”, “cacao mass”, “kakao mass” or “mass” in Germany and several European countries); cocoa powder; lard; palm kernel oil; coconut oil; tallow; and hydrogenated oils such as hydrogenated soy oil.

An SFC value is determined by detecting the NMR signal from both liquid and solid components in the fat sample, or by detecting the change in the liquid signal as it is displaced by solid. Such methods of NMR analysis to determine SFC are described in AOCA Cd 16v-93 revised in 2000 (direct method).

Non-limiting examples of fat replacement coating components include: hydrophobic coatings; celluloses; gums; octenyl-succinyl maltodextrins; starches; hydrophobic derivitized starches; protein blends; microparticulated protein; emulsifiers; caprenin; salatrim; olestra; and combinations thereof.

The coating component is present in an amount of from about 5% to about 20%, alternatively from about 5% to about 15%, and alternatively from about 10% to about 12%, by weight of said composition.

### Wetting Components

The compositions may include a wetting component to ensure good, homogeneous mixing of the dough. Wetting components useful in the compositions are generally in liquid form and may be fat components, emulsifiers, liquid sugars, polyols (polydextrose, maltitol, erythritol, sorbitol) and other components that may lend wetting properties to components of the composition.

If fat components are used, they can be saturated or un-saturated, solid or liquid at 25° C., and but preferably liquid at room temperature, with a solid fat content (SFC) of less than about 15%. Particularly useful wetting components are derived from plants, and include vegetable fats and fats from plant seeds, though animal fats could be used.

Non-limiting examples of particularly useful wetting components include the following: corn oil; sunflower oil; safflower oil; soya bean oil; peanut oil; olive oil; rapeseed oil (canola oil); emulsifiers; liquid sugars; polyols; polydextrose; maltitol; erythritol; sorbitol; and combinations thereof.

The wetting component is present in an amount from about 1% to about 5%, and alternatively from about 3% to about 4%, by weight of said composition.

Coating component plus wetting component is in a total amount from about 6% to about 25%, alternatively from about 10% to about 20%, and alternatively from about 10% to about 15%, by weight of the composition.

### Optional Ingredients

The compositions may also include various optional ingredients that are known or otherwise effective for use in ingestible fiber containing compositions formed as a dough during making, particularly baked goods, provided that the optional ingredients are physically and chemically compatible with the dietary fiber, coating and wetting components defined herein or do not otherwise unduly impair product stability, aesthetics, or performance. The choice and quantities of optional ingredients will vary depending on the desired properties of the end product. Therefore, the optional components are used in quantities sufficient to achieve desired formulation characteristics.

Non-limiting examples of optional ingredients suitable for use herein include materials such as flour components, sweetening agents, water, emulsifiers, leavening agents, milk products, egg products, colors, flavors, preservatives, antioxidants, pharmaceutically active agents, probitoic microorganisms, vitamins, minerals and combinations thereof.

The optional ingredients may be included in amounts ranging from about 0.01% to about 50%, alternatively from about 0.5% to about 40%, and alternatively from about 0.5% to about 35%, by weight of the composition.

### Flour

The compositions can include one or more flour components. Any type of flour which is suitable for making dough can be used. Non-limiting examples of suitable flours include wheat, whole wheat, rye, corn, cottonseed meal, sourghum flour and combinations thereof. Wheat flour is particularly useful herein and can be bleached or unbleached. Additionally, starches can constitute a portion of the flour component. Pregelatinized food starches (e.g. pregelatinized wheat starch, pregelatinized corn starch) can also be used. Various flours and starches are commercially available.

The flour component can be present in amounts of from about 10% to about 50%, alternatively from about 10% to about 40%, alternatively from about 20% to about 40%, and alternatively from about 30% to about 40%, by weight of the composition.

### Water

Water may be added to the composition as a processing aid to facilitate dough formation and the amount added, if any, may vary as needed for processing. Water can be present in amounts from about 1% to about 14%, alternatively from about 2% to about 8%, and alternatively from about 3% to about 6% by weight of the dough composition, during processing. However, if water is used in processing, water is lost during baking/cooking of the composition such that the final composition is substantially free of water. Water may also be present simply from various ingredients used in the compositions, such as, for example molasses. By “substantially free” is meant that total water in the finished product is present from about 0% to less than about 4.5%, alternatively from about 1.5% to about 4.5%, and alternatively from about 3% to about 4%, by weight of the finished baked product.

Water loss during processing can be measured by the standard procedure included as instructions with a Mettler LP-16 drying unit used to dry the composition after baking for determining a Loss on Drying Measurement (LOD) as would be understood by one of skill in the art.

### Sweetener

The compositions may include a sweetener. Non-limiting examples of useful sweeteners include mono-, di-, and polysaccharides such as fructose, sucrose, glucose, xylose, ribose, mannose, galactose, dextrose, maltose; partially hydrolyzed starch or corn syrup solids; sugar alcohols and combinations thereof. Non-limiting examples of sweeteners also include materials such as invert sugar syrups, brownulated sugar, molasses, honey, maple syrup and the like and combinations thereof. Non-limiting examples of sweeteners also include artificial sweeteners such as sucralose, aspartame, acesulfame potassium, saccharin, cyclamate, gem sweet, L-sugars, trichloro sucrose, aspartyl-D-valine, glycyrrhizin, p-phenetylurea, hydrochalcone and the like, and combinations thereof.

Such sweeteners may be included in the compositions in amounts of from about 0% to about 20%, alternatively from about 0.1% to about 10%, and alternatively from about 0.5% to about 8%, by weight of the composition.

### Emulsifier

The compositions may include one or more emulsifiers. Emulsifiers are commonly used and frequently referred to also as “dough conditioners” because they help control the consistency of dough. Non-limiting examples of suitable emulsifiers include lecithins, mono- and diglycerides and fatty acids, sucrose partial fatty acid esters, sorbitan esters of fatty acids, polyoxyethylene sorbitan esters of fatty acids, propylene glycol esters, polyethylene glycol esters, ethoxylated mono- and diglycerides, fumarated esters of monoglycerides or their alkali metal salts, alkanoyl lactylates or their metal salts and the like and combinations thereof. Lecithin is a particularly useful emulsifier.

Emulsifiers may be included in the compositions in amounts of from 0.01% to about 10%, alternatively from 0.1% to about 5%, and alternatively from about 1% to about 3%, by weight of the composition.

### Leavening Agent

The compositions may include one or more leavening agents, including non-yeast leavening agents. Non-yeast leavening agents include a source of carbon dioxide. Non-limiting examples of leavening agents include sodium bicarbonate (baking soda) and potassium bicarbonate, either alone or in combination with a leavening acid, non-limiting examples of which include monocalcium phosphate, dicalcium phosphate, sodium acid pyrophosphate, sodium aluminum sulfate, sodium aluminum phosphate, potassium acid tartrate and combinations thereof.

Leavening agents may be included in the compositions in amounts of from about 0.01% to about 10%, alternatively from about 0.1% to about 5%, and alternatively from about 0.5% to about 1%, by weight of the composition.

### Flavor

The compositions may include one or more flavoring agents. Flavoring agents include volatile oils, liquids or dry agents which are pharmaceutically acceptable for oral ingestion by mammals, particularly humans. Non-limiting examples of flavoring agents include, fruit flavors such as orange, lemon, peach, apple, apricot, banana; chocolate; cocoa powder; vanilla; vanilla cream; mint including peppermint and spearmint; spices and or spice flavors including cinnamon, ginger, nutmeg, clove; and nut flavors including hazelnut, peanut butter, almond; and the like and combinations thereof. Additionally, superfruit flavors or extracts such as pomegranate, acai, goji berry and combinations thereof may be used.

The flavoring agent may be included in the composition in amounts of from about 0.01% to about 20%, alternatively from about 0.1% to about 10%, alternatively from about 0.5% to about 10%, by weight of the composition.

The compositions may also include other optional ingredients, non-limiting examples of which include milk products such as whole milk, skim milk, buttermilk, whey, concentrated milk product (condensed or evaporated milk), dried milk products, non-fat milk powder, dry whole milk, modified whole milk and combinations thereof; egg whites and egg yolks; other protein sources including soy protein; preservatives such as sorbic acid; polyhydric alcohols including glycerol and propylene glycol; modified celluloses; antioxidants including ascorbic acid; vitamins, minerals, coloring agents, dyes, and combinations thereof.

### Pharmaceutically Active Agents

Pharmaceutically active agents may also be included in the compositions. Non-limiting examples of such pharmaceutically active agents include laxatives; analgesics; cholesterol reducing agents, and the like, and mixtures thereof. Pharmaceutically active agents can be included in amounts to deliver a safe and therapeutically effective dose of the desired pharmaceutically active agent.

### Probiotic Microorganisms

Probiotic microorganisms may also be included in the compositions, or in toppings on or around the compositions. The term “probiotic microorganism” as used herein is generally understood to be microorganisms which beneficially affect a host by improving the host's intestinal microbial balance and which exert healthy effects beyond basic nutrition when ingested in sufficient numbers. Included in “probiotic microorganism” are microorganisms which are viable or dead; processed compositions of micro-organisms; their constituents such as proteins or carbohydrates, or purified fractions of bacterial ferments that beneficially affect a host. The general use of probiotic microorganisms is in the form of viable cells. However, it may be extended to non-viable cells such as killed cultures or compositions containing beneficial factors expressed by the probiotic microorgansism. This may include thermally killed microorganisms, or microorganisms killed by exposure to altered pH or subjected to pressure. For the purpose of the present invention, “probiotic microorganism” is further intended to include the metabolites generated by the microorganisms during fermentation, if they are not separately indicated. These metabolites may be released to the medium of fermentation, or they may be stored within the microorganism. As used herein “probiotic microorganism” also includes bacteria, bacterial homogenates, bacterial proteins, bacterial extracts, bacterial ferment supernatants and combinations thereof, which perform beneficial functions to the host animal when given at a therapeutic dose.

Useful probiotic microorganisms include at least one lactic acid and/or acetic acid and/or propionic acid producing bacteria—i.e. microbes that produce lactic acid and/or acetic acid and/or propionic acid by decomposing carbohydrates such as glucose and lactose. Preferably, the probiotic microorganism is a lactic acid bacteria. Generally, as used herein, lactic acid bacteria include Lactobacillus, Leuconostoc, Pediococcus, Streptococcus, and Bifidobacterium. Suitable probioitc microorganisms can also include other microorganisms which beneficially affect a host by improving the host's intestinal microbial balance, such as, but not limited to yeasts such as Saccharomyces, Debaromyces, Candida, Pichia and Torulopsis, molds such as Aspergillus, Rhizopus, Mucor, and Penicillium and Torulopsis, and other bacteria such as but not limited to the genera Bacteriodes, Clostridium, Fusobacterium, Melissococcus, Propionibacterium, Enterococcus, Lactococcus, Staphylococcus, Peptostreptococcus, Bacillus, Pediococcus, Micrococcus, Leuconostoc, Weissella, Aerococcus, and Oenococcus, and combinations thereof.

Non-limiting examples of lactic acid bacteria useful in the present invention include strains of Streptococcus lactis, Streptococcus cremoris, Streptococcus diacetylactis, Streptococcus thermophilus, Lactobacillus bulgaricus, Lactobacillus acidophilus, Lactobacillus helveticus, Lactobacillus bifidus, Lactobacillus casei, Lactobacillus lactis, Lactobacillus plantarum, Lactobacillus rhamnosus, Lactobacillus delbruekii, Lactobacillus thermophilus, Lactobacillus fermentii, Lactobacillus salivarius, Lactobacillus paracasei, Lactobacillus brevis, Bifidobacterium longum, Bifidobacterium infantis, Bifidobacterium bifidum, Bifidobcterium animalis, Bifidobcterium lactis, Bifidobcterium breve, Bifidobcterium adolescentis, and Pediococcus cerevisiae and combinations thereof, in particular Lactobacillus, Bifidobacterium, and combinations thereof.

Probiotic microorganisms which are particularly useful with the present invention include those which (for human administration) are of human origin (or of the origin of the mammal to which the probiotic microorganism is being administered), are non-pathogenic to the host, resist technological processes (i.e. can remain viable and active during processing and in delivery vehicles), are resistant to gastric acidity and bile toxicity, adhere to gut epithelial tissue, have the ability to colonize the gastrointestinal tract, produce antimicrobial substances, modulate immune response in the host, and influence metabolic activity (e.g. cholesterol assimilation, lactase activity, vitamin production).

Of particular interest herein are Bifidobacteria, because while all of the functions of endogenous Bifidobacteria in the colon have not been completely elucidated, it is recognized that exclusively breast-fed infants have a reduced risk of diarrhea compared with formula-fed infants. The fact that the breast-fed infants have greater numbers of colonic Bifidobacteria may in part explain this observed health advantage. In addition, it has been found that patients suffering from active Crohn's disease have significantly less recoverable Bifidobacteria in their feces compared with healthy individuals. Such results support suggestions that strains of Bifidobacteria may play important roles in maintaining a balanced healthy intestinal microflora, and thereby promote gastrointestinal health.

As a non-limiting example, strains of Bifidobacterium isolated from resected and washed human gastrointestinal tract may be used. An example includes Bifidobacterium infantis strain designated UCC35624, described as being deposited at the National Collections of Industrial and Marine Bacteria Ltd (NCIMB) on Jan. 13, 1999, and accorded the accession number NCIMB 41003 and described in U.S. Pat. No. 7,195,906.

The probiotic microorganism can be included in the compositions as a single strain or a combination of multiple strains, wherein the total number of bacteria in a dose of probiotic microorganism is typically from about 1×10³ to about 1×10¹⁴, alternatively from about 1×10⁵ to about 1×10¹², and alternatively from about 1×10⁷ to about 1×10¹¹ CFU per dose.

The probiotic microorganisms can be incorporated into the compositions while the probiotic microorganism is alive but in a state of “suspended animation” or somnolence. Once freeze-dried, the viable cultures(s) of probiotic microorganism are handled so as to minimize exposure to moisture that would reanimate the cultures because, once reanimated, the cultures can experience high rates of morbidity unless soon cultured in a high moisture environment or medium. Additionally, the cultures are handled to reduce possible exposure to high temperatures (particularly in the presence of moisture) to reduce morbidity.

The probiotic microorganisms are preferably used in a powdered, dry form. The probiotic microorganisms can also be administered in the composition or in a separate composition, administered at the same time or different time as the compositions.

### Method of Using

The present invention also relates to methods for promoting gastrointestinal and/or cardiovascular health comprising administering to a mammal an effective amount of a composition comprising a gelling dietary fiber and a non-gelling dietary fiber in a weight ratio of from about 5:1 to about 1:2.5; a coating component and wetting component in a weight ratio of from about 20:1 to about 1:1; and wherein a weight ratio of coating component plus wetting component to gelling dietary fiber or non-gelling dietary fiber of from about 25:1 to about 1:5. The present invention also includes methods for promoting cardiovascular health, comprising administering to a mammal an effective amount of the compositions.

As used herein, “promoting” gastrointestinal health includes preventing, treating and maintaining protection against, episodic (including acute or chronic) gastrointestinal disturbances non-limiting examples of which include lower gastrointestinal tract conditions including, but not limited to, functional digestive disorders (including but not limited to irritable bowel syndrome, temperamental digestive systems, constipation dominant, diarrhea dominant, and alternating constipation/diarrhea), inflammatory bowel disease, constipation, diarrhea (including traveler's diarrhea), bloating, flatulence, abdominal cramping, abdominal pain, gas, Crohn's Disease, ulcerative colitis, diverticulitis, microscopic colitis, diverticular disease, dyspepsia, small intestinal bacterial overgrowth, lactose intolerance, celiac disease, and the like; and upper gastrointestinal tract conditions, examples of which include, but are not limited to, gastroesophageal reflux disease (GERD), erosive esophagitis, gastroparesis, gastritis, gastric ulcers, duodenal ulcers, heartburn (including frequent heartburn), functional dyspepsia, indigestion, posterior laryngitis, hypersecretory conditions, such as Zollinger-Ellison syndrome, multiple endocrine adenomas and systemic mastocytosis and the like, and combinations thereof.

As used herein, promoting cardiovascular health includes preventing, treating, and maintaining protection against hypercholesterolemia and hypertension and achieving and maintaining normal ratios of LDL, HDL and triglycerides.

As used herein “preventing” means providing effects against a probable or possible disease or condition to keep the disease or condition from occurring. As used herein “treating” means caring for to improve, alter, alleviate and/or eliminate the effects and/or symptoms of a disease or condition. As used herein “maintaining” protection against means to preserve and/or sustain one's health and/or body condition against disease, failure and/or decline and to support or provide for continued absence of disease, failure and/or decline.

As used herein “effective amount” means an amount necessary to achieve a desired selected result.

The composition can be administered orally, in one or more doses, and can be administered as needed, daily, every other day, weekly, every other week, monthly, and chronically. Administration will vary depending on the user's needs and objective—i.e. maintaining daily fiber intake, lowering cholesterol, controlling episodic gastrointestinal disturbances, etc.

A serving or dose of the composition may be administered as a single serving or dose, administered once per day, or the full dosage may be taken at multiple times throughout the course of a day. Additionally, in some cases, for example for initial use for laxation treatment for example, multiple doses can be taken per day, and following, for maintenance and regularity, a single dose can be taken per day. By way of non-limiting example for wafers, consumers may take a two wafer dose or serving up to 3 times daily for a total of 3 doses (6 wafers).

A non-limiting example of an embodiment of the method includes administering from about 0.5 g to about 5 g of gelling dietary fiber per dose/serving, which can be administered as a single administration or the dose/serving can be broken into multiple administrations. In addition, multiple doses/servings can be consumed in a day, (for example, for initial stimulation of laxation for treatment of constipation.) The example method also includes administering from about 0.5 g to about 7 g of non-gelling dietary fiber per dose/serving, which can be administered in a single administration or multiple administrations. A typical dose/serving of about 1.8 g of gelling dietary fiber and 1.9 g of non-gelling dietary fiber can be administered in two wafers, each wafer containing about 0.9 g of gelling dietary fiber and about 0.95 g of non-gelling dietary fiber. The entire dose/serving be administered at once or each wafer eaten at different times to attain the entire dose/serving.

The method may also include administering a probiotic microorganism either in the same composition with the gelling and non-gelling dietary fibers, or in a separate composition which may be administered separately or which may be used, for example in a topping on, or filling in, the composition containing the gelling and non-gelling dietary fibers. The method comprises administering from about 1×10³ to about 1×10¹⁴ CFU, alternatively about 1×10³ to about 1×10¹² CFU, and alternatively about 1×10⁵ to about 1×10¹¹ CFU of said probiotic microorganism to said mammal per dose.

### Method of Making

An example method of making a composition of the present invention is as follows. The methods described below represent non-limiting example methods. Industrial scale methods can also be used, such as for example rotary molding methods to form wafers, as would be understood by one of skill in the art.

### Method of Making a Wafer Containing Gelling and Non-Gelling Dietary Fiber

1. Heat palm oil to 55° C. in a first mixing vessel.
2. Weigh and add lecithin, sucralose and chocolate flavor to palm oil; mix for 4 minutes; maintain at 55° C. to yield coating premix.
3. Weigh and add inulin and corn oil to the first mixing vessel and mix to yield coating plus wetting premix.
4. Weigh and add flavor mix (jet black cocoa, redwood cocoa, fructose, sucrose, brownulated sugar, molasses and water (if needed) to a second mixing vessel and mix for 2 minutes.
5. Weigh and add oat hull fiber to a third mixing vessel; add coating plus wetting premix; add flavor premix and mix for 2 minutes.
6. Weigh and add flour and baking soda to the third mixing vessel and mix for 3 minutes.
7. Roll dough out onto a baking tray to a thickness of approximately 6 mm.
8. Cut into desired shape(s) (i.e. with a cookie cutter) and bake in an oven at 220° C. for 10-12 minutes.
9. Allow to cool.

### Method of Making a Wafer Containing Non-Gelling Dietary Fiber and Having a Topping Containing Gelling Dietary Fiber

### Wafer

1. Heat palm oil to 55° C. in a first mixing vessel.
2. Weigh and add lecithin, sucralose and chocolate flavor to palm oil; mix for 4 minutes; maintain at 55° C. to yield coating premix.
3. Weigh and add inulin and corn oil to the first mixing vessel and mix for 4 minutes to yield coating plus wetting premix.
4. Weigh and add flavor mix (jet black cocoa, redwood cocoa, fructose, sucrose, brownulated sugar, molasses and water (if needed) to a second mixing vessel and mix for 2 minutes to yield flavor premix.
5. Weigh and add oat hull fiber to a third mixing vessel; add coating plus wetting premix and flavor premix and mix for 2 minutes.
6. Weigh and add flour and baking soda to the third mixing vessel and mix for 3 minutes.
7. Roll dough out onto a baking tray to a thickness of approximately 6 mm.
8. Cut into desired shape(s) (i.e. with a cookie cutter) and bake in an oven at 220° C. for 10-12 minutes.
9. Allow to cool.

### Topping

1. Weigh psyllium (in a fume hood).
2. Weigh solid chocolate (811NV) and heat to 45° C. until fully melted.
3. Add psyllium to the melted chocolate and mix well (in fume hood until psyllium is coated).
4. Maintain psyllium/chocolate mixture at 45° C. and spread the topping on wafers and allow to cool.

### EXAMPLES

The following examples further describe and demonstrate embodiments within the scope of the present invention. The examples are given solely for the purpose of illustration and are not to be construed as limitations of the present invention, as many variations thereof are possible without departing from the spirit and scope of the invention. All exemplified concentrations are weight-weight percents, unless otherwise specified.

Compositions comprising a gelling dietary fiber and a non-gelling dietary fiber are exemplified below. The compositions can be administered to a mammal to promote gastrointestinal health and/or cardiovascular health.

### Example 1

Below is an example of a composition of the invention suitable for use in the method of the invention. The composition is formed by combining and mixing the ingredients as described above. The composition is administered to a mammal to promote gastrointestional and/or cardiovascular health.

| Ingredient | Weight % (per finished product) |
|---|---|
| Fructose | 7.87 |
| Sucrose | 4.15 |
| Brownulated Sugar | 4.86 |
| Granulated Molasses | 0.46 |
| Soy Lecithin | 1.04 |
| Palm Kernel Oil | 9.95 |
| Corn Oil | 3.31 |
| Flavor 2053592 | 0.47 |
| Inulin IN-S2 | 7.88 |
| Psyllium | 7.30 |
| Oat Hull Fiber | 7.39 |
| Redwood Cocoa | 6.25 |
| Jet Black Cocoa | 4.17 |
| Baking Soda | 0.74 |
| Flour | 34.14 |
| Sucralose | 0.02 |
| Total | 100.0 |

Fructose available from Tate&Lyle, Decatur, IL, USA
Sucrose available from Michigan Sugar, Bay City, MI, USA
Brownulated Sugar available from Hurst, Indianapolis, IN, USA
Granulated Molasses available from Hurst, Indianapolis, IN, USA
Soy Lecithin available from Solae, Decatur, IN, USA
Palm Kernel Oil available from Bunge, Bradley, IL, USA
Corn Oil available from Cargill, Memphis, TN, USA
Flavor 2053592 O-type flavor, available from Sensient, Indianapolis, IN, USA
Inulin Oliggofiber available from Cargill, Minneapolis, MN, USA
Psyllium Mucilloid Steam Sanitized, available from the Procter & Gamble Company, Cincinnati, OH, USA
Oat Hull Fiber Oat Fiber 200, available from Sun Opta, Chelmsford, MA, USA
Redwood Cocoa available from Blommer Chocolate Co., Chicago, IL, USA
Jet Black Cocoa available from Blommer Chocolate Co., Chicago, IL, USA
Baking Soda available from Church & Dwight, Old Fort, OH, USA
Flour Straight Grade Flour, available from Nagel, Cincinnati, OH, USA
Sucralose available from Tate&Lyle, Decatur, IL, USA

### Example 2

Below is an example of a composition of the invention suitable for use in the method of the invention. The composition is formed by combining and mixing the ingredients as described above. The composition is administered to a mammal to promote gastrointestional and/or cardiovascular health.

| | Weight % (per an uncooked |
|---|---|
| Ingredient | dough composition) |
| Sucrose | 22.31 |
| Flour | 31.27 |
| Sodium Bicarbonate (Baking Soda) | 0.18 |
| Flavor | 1.54 |
| Oat Hull Fiber | 1.60 |
| Molassses | 0.36 |
| Water | 7.84 |
| Table Oats | 8.18 |
| Oil (50% corn oil/50% palm kernel oil) | 10.41 |
| Inulin IN-S2 | 4.73 |
| Psyllium | 11.58 |
| Total | 100 |

Sucrose available from Michigan Sugar, Bay City, MI, USA
Flour Straight Grade Flour, available from Nagel, Cincinnati, OH, USA
Sodium Bicarbonate (Baking Soda) available from Church & Dwight, Old Fort, OH, USA
Flavor O-type flavor, available from Sensient, Indianapolis, IN, USA
Oat Hull Fiber Oat Fiber 200, available from Sun Opta, Chelmsford, MA, USA
Granulated Molasses available from Hurst, Indianapolis, IN, USA
Table Oats availale from Grain Millers, Yorkton, Saskatchewan, Canada
Palm Kernel Oil available from Bunge, Bradley, IL, USA
Corn Oil available from Cargill, Memphis, TN, USA
Inulin Oliggofiber available from Cargill, Minneapolis, MN, USA
Psyllium Mucilloid Steam Sanitized, available from the Procter & Gamble Company, Cincinnati, OH, USA

### Example 3

Below is an example of a composition of the invention suitable for use in the method of the invention. The composition is formed by combining and mixing the ingredients as described above for a wafer with a topping. The composition is administered to a mammal to promote gastrointestional and/or cardiovascular health.

| | |
|---|---|
| Ingredient | Weight % (per finished product) |

Wafer

| | |
|---|---|
| Fructose | 8.49 |
| Sucrose | 4.48 |
| Brownulated Sugar | 5.24 |
| Granulated Molasses | 0.50 |
| Soy Lecithin | 1.12 |
| Palm Kernel Oil | 10.73 |
| Corn Oil | 3.57 |
| Flavor 2053592 | 0.51 |
| Inulin IN-S2 | 8.50 |
| Oat Hull Fiber | 7.97 |
| Redwood Cocoa | 6.74 |
| Jet Black Cocoa | 4.50 |
| Baking Soda | 0.80 |
| Flour | 36.83 |
| Sucralose | 0.02 |
| Total | 100.0 |

Topping

| | |
|---|---|
| Chocolate (811NV) | 70.3 |
| Psyllium | 29.7 |
| Total | 100% |

Fructose available from Tate&Lyle, Decatur, IL, USA
Sucrose available from Michigan Sugar, Bay City, MI, USA
Brownulated Sugar available from Hurst, Indianapolis, IN, USA
Granulated Molasses available from Hurst, Indianapolis, IN, USA
Soy Lecithin available from Solae, Decatur, IN, USA
Palm Kernel Oil available from Bunge, Bradley, IL, USA
Corn Oil available from Cargill, Memphis, TN, USA
Flavor 2053592 O-type flavor, available from Sensient, Indianapolis, IN, USA
Inulin Oliggofiber available from Cargill, Minneapolis, MN, USA
Oat Hull Fiber Oat Fiber 200, available from Sun Opta, Chelmsford, MA, USA
Redwood Cocoa available from Blommer Chocolate Co., Chicago, IL, USA
Jet Black Cocoa available from Blommer Chocolate Co., Chicago, IL, USA
Baking Soda available from Church & Dwight, Old Fort, OH, USA
Flour Straight Grade Flour, available from Nagel, Cincinnati, OH, USA
Sucralose available from Tate&Lyle, Decatur, IL, USA
Chocolate (811NV) available from Barry Callebaut, Zurich, Switzerland
Psyllium Mucilloid Steam Sanitized, available from the Procter & Gamble Company, Cincinnati, OH, USA

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A composition for promoting gastrointestinal and/or cardiovascular health comprising:
a gelling dietary fiber and a non-gelling dietary fiber in a weight ratio of about 5:1 to about 1:2.5;
a coating component, and a wetting component in a weight ratio of from about 20:1 to about 1:1; and
wherein a weight ratio of coating component plus wetting component to said gelling dietary fiber or said non-gelling dietary fiber is from about 25:1 to about 1:5.

2. The composition of claim 1 wherein said gelling dietary fiber is selected from the group consisting of: psyllium; non-modified pectins; guar gum; locust bean gum; konjac; xanthan gum; glucomannans; galactomannans; beta-glucans; arabinans; galactans; aligns; agar; methylcelluloses; propylcelluloses; hydroxypropylmethyl cellulose; carboxymethyl cellulose; gelling carrageenans; and combinations thereof.

3. The composition of claim 1 wherein said non-gelling dietary fiber is selected from the group consisting of: inulin; gum arabic; larch arabinogalactan; resistant dextrins; high methoxyl pectin; cellulose; raffinose; stachyose; fructooligosaccharides; soy oligosaccharides; galactooligosaccharides; gentioligosaccharides; xylooligosaccharides; isomaltooligosaccharides; arabino-xylanoligosaccharides; lactulose; hydrolyzed guar gum; lignins; oat hull fiber; oat bran; wheat bran; rice bran; carageenans; retrograded starch; resistant starch; slow digesting starch; resistant maltodextrins; sugar beet fiber; oilseed fibers; and combinations thereof.

4. The composition of claim 1 wherein said coating component is selected from the group consisting of: chocolate; cocoa butter; cocoa liquor; cocoa powder; lard; palm kernel oil; coconut oil; tallow; hydrogenated soy oil; hydrogenated fats, non-fat hydrophobic coatings; celluloses; gums; octenyl-succinyl maltodextrins; starches; hydrophobic derivatized starches; protein blends; microparticulated protein; emulsifiers; caprenin salatrim; olestra; and combinations thereof.

5. The composition of claim 1 wherein said wetting component is selected from the group consisting of: corn oil, sunflower oil; safflower oil; soya bean oil; peanut oil; olive oil; rapeseed oil; emulsifiers; liquid sugars; polyols; polydextrose; maltitol; erythritol; sorbitol; and combinations thereof.

6. The composition of claim 1 comprising from about 1% to about 15% by weight of said composition, of said gelling dietary fiber.

7. The composition of claim 1 comprising from about 1% to about 30% by weight of said composition, of said non-gelling dietary fiber.

8. The composition of claim 1 comprising from about 5% to about 20%, by weight of said composition, of said coating component.

9. The composition of claim 1 comprising from about 1% to about 5%, by weight of said composition, of said wetting component.

10. The composition of claim 1 comprising from about 6% to about 25%, by weight of said composition, of said coating component plus said wetting component.

11. The composition of claim 1 further comprising from about 5% to about 10%, by weight of said composition, of an additional gelling or non-gelling dietary fiber.

12. The composition of claim 1 further comprising a probiotic microorganism.

13. The composition of claim 12 comprising from about 1×10³ to about 1×10¹⁴ CFU of said probiotic microorganism per dose.

14. The composition of claim 1 wherein said composition provides about 0.5 g to about 5 g of gelling dietary fiber per dose.

15. The composition of claim 1 wherein said composition provides about 0.5 g to about 7 g of non-gelling dietary fiber per dose.

16. The composition of claim 1 wherein said composition is in a form selected from the group consisting of: a wafer, a cookie, a bar, a chewable tablet and combinations thereof.

17. The composition of claim 1 further comprising a topping comprising a component selected from the group consisting of: a probiotic microorganism; an additional gelling dietary fiber; an additional non-gelling dietary fiber; a vitamin; a mineral; and combinations thereof.

18. A composition for promoting gastrointestinal and/or cardiovascular health comprising:
a gelling dietary fiber component;
a non-gelling dietary fiber component; and
an amount of a coating component sufficient to coat the particles of said gelling dietary fiber component, such that the water-absorbing ability of said composition is reduced, and
the organoleptic properties of said composition are improved.

19. The composition of claim 18 wherein said gelling dietary fiber is selected from the group consisting of: psyllium; non-modified pectins; guar gum; locust bean gum; konjac; xanthan gum; glucomannans; galactomannans; beta-glucans; arabinans; galactans; aligns; agar; methylcelluloses; propylcelluloses; hydroxypropylmethyl cellulose; carboxymethyl cellulose; gelling carrageenans; and combinations thereof.

20. The composition of claim 18 wherein said non-gelling dietary fiber is selected from the group consisting of inulin; gum arabic; larch arabinogalactan; resistant dextrins; high methoxyl pectin; cellulose; raffinose; stachyose; fructooligosaccharides; soy oligosaccharides; galactooligosaccharides; gentioligosaccharides; xylooligosaccharides; isomaltooligosaccharides; arabino-xylanoligosaccharides; lactulose; hydrolyzed guar gum; lignins; oat hull fiber; oat bran; wheat bran; rice bran; carageenans; retrograded starch; resistant starch; slow digesting starch; resistant maltodextrins; sugar beet fiber; oilseed fibers; and combinations thereof.

21. The composition of claim 18 wherein said coating component is selected from the group consisting of: chocolate; cocoa butter; cocoa liquor; cocoa powder; lard; palm kernel oil; coconut oil; tallow; hydrogenated soy oil; non-fat hydrophobic coatings; celluloses; gums; octenyl-succinyl maltodextrins; starches; hydrophobic derivatized starches; protein blends; microparticulated protein; emulsifiers; caprenin salatrim; olestra; and combinations thereof.

22. The composition of claim 18 wherein said wetting component is selected from the group consisting of: corn oil; sunflower oil; safflower oil; soya bean oil; peanut oil; olive oil; rapeseed oil; emulsifiers; liquid sugars; polyols; polydextrose; maltitol; erythritol; sorbitol; and combinations thereof.

23. The composition of claim 18 comprising from about 5% to about 20%, by weight of said composition, of said coating component.

24. A method for promoting gastrointestinal and/or cardiovascular health comprising administering to a mammal an effective amount of a composition comprising:
a gelling dietary fiber and a non-gelling dietary fiber in a weight ratio of from about 5:1 to about 1:2.5;
a coating component and a wetting component in a weight ratio of from about 20:1 to about 1:1; and
wherein a weight ratio of coating component plus wetting component to said gelling dietary fiber or said non-gelling dietary fiber is about 25:1 to about 1:5.

25. The method of claim 24 comprising administering a gelling dietary fiber selected from the group consisting of: psyllium; non-modified pectins; guar gum; locust bean gum; konjac; xanthan gum; glucomannans; galactomannans; beta-glucans; arabinans; galactans; aligns; agar; methylcelluloses; propylcelluloses; hydroxypropylmethyl cellulose; carboxymethyl cellulose; gelling carrageenans; and combinations thereof.

26. The method of claim 24 comprising administering a non-gelling dietary fiber selected from the group consisting of: inulin; gum arabic; larch arabinogalactan; resistant dextrins; high methoxyl pectin; cellulose; raffinose; stachyose; fructooligosaccharides; soy oligosaccharides; galactooligosaccharides; gentioligosaccharides; xylooligosaccharides; isomaltooligosaccharides; arabino-xylanoligosaccharides; lactulose; hydrolyzed guar gum; lignins; oat hull fiber; oat bran; wheat bran; rice bran; carageenans; retrograded starch; resistant starch; slow digesting starch; resistant maltodextrins; sugar beet fiber; oilseed fibers; and combinations thereof.

27. The method of claim 24 further comprising an additional gelling or non-gelling dietary fiber, and combinations thereof.

28. The method of claim 24 further comprising administering a probiotic microorganism.

29. The method of claim 24 comprising administering from about 1×10³ to about 1×10¹⁴ CFU of said probiotic microorganism to said mammal per dose.

30. The method of claim 24 comprising administering from about 0.5 g to about 4 g of gelling dietary fiber per dose.

31. The method of claim 24 comprising administering from about 0.5 g to about 7 g of non-gelling dietary fiber per dose.

32. A composition for promoting gastrointestinal and/or cardiovascular health comprising:
a gelling dietary fiber and a non-gelling dietary fiber in a weight ratio of about 1:1;
a coating component and a wetting component in a weight ratio of about 3:1; and
wherein a weight ratio of coating plus wetting component to said gelling dietary fiber or said non-gelling dietary fiber is about 1:1.

33. The composition of claim 32 wherein said gelling dietary fiber is psyllium and said non-gelling dietary fiber is inulin.

34. The composition of claim 32 wherein said coating component is palm kernel oil and said wetting component is corn oil.
